(19) United States
(12) Patent Application Publication
(10) Pub. No.: US 2013/0221018 A1
(43) Pub. Date: Aug. 29, 2013

(54) VENDING MACHINE METHOD AND APPARATUS

(71) Applicant: BRENT D. GARSON, Orange, OH (US)

(72) Inventor: BRENT D. GARSON, Orange, OH (US)

(21) Appl. No.: 13/405,629

(22) Filed: Feb. 27, 2012

(51) Int. Cl. G07F 11/00; B65G 59/00

(52) U.S. Cl. 221/1

(57) ABSTRACT

A vending machine has a plurality of product dispensing devices which dispense selected products for movement to a product retrieval location. A selected product is in a first orientation as it moves to the product retrieval location. The orientation of the selected product is changed from the first orientation to a second orientation at the product retrieval location. To change the orientation of the selected product, force is applied to an end portion of the selected product. This force may be applied in many different ways, including by a movable surface on a belt or a movable surface on a sweeper member.

### BACKGROUND OF THE INVENTION

The present invention relates to new and improved method and apparatus for use in a vending machine which dispenses products to customers.

Vending machines have been utilized to provide various snacks, beverages and other products to customers. The vending machines dispense selected products to customers in response to insertion of money. A known vending machine is disclosed in U.S. Pat. No. 6,732,014.

In order to facilitate access to a vending machine by a customer having a disability, it may be desired to have a product retrieval location where a dispensed product is accessible to a customer, at a level above the level disclosed in the aforementioned patent. If this is to be done, it is desirable to have the vertical extent of the product retrieval location as small as possible in order to maximize the number of products which can be stored and dispensed by the vending machine.

### SUMMARY OF THE INVENTION

The present invention provides an improved method and apparatus for use in association with a vending machine having a plurality of product dispensing devices and a product retrieval location where a customer has access to a selected product. The selected product is moved from one of the product dispensing devices to the product retrieval location. The selected product moves to the product retrieval location in a first orientation. The orientation of the selected product is changed from the first orientation to a second orientation while the selected product is at the product retrieval location.

The vertical extent of the selected product may be greater when it is in the first orientation than when it is in the second orientation. By having the vertical extent of the product minimized when the product is in the second orientation, the vertical extent of the product retrieval location may be minimized.

To change the orientation of the selected product from the first orientation to the second orientation, a force may be applied to a lower end portion of the selected product. This may be accomplished by moving a surface while an end portion of the selected product is in engagement with the surface. Alternatively, the orientation of the selected product may be changed from the first orientation to the second orientation by moving a sweeper member across a surface which is engaged by the selected product.

The present invention has a number of different features. These features may be utilized together as disclosed herein. These features may be utilized separately and/or in various combinations with each other or the prior art.

### BRIEF DESCRIPTION OF THE DRAWINGS

The foregoing and other features of the present invention will become more apparent upon a consideration of the following description taken in connection with the accompanying drawings wherein:

FIG. 1 is a fragmentary schematic sectional view of a vending machine which is constructed and operated in accordance with the present invention;

FIG. 2 is an enlarged fragmentary schematic sectional view of a product retrieval location in the vending machine of FIG. 1;

FIG. 3 is a fragmentary schematic front pictorial illustration of the product retrieval location used in the vending machine of FIG. 1;

FIG. 4 is a fragmentary schematic rear pictorial view of the product retrieval location in the vending machine of FIG. 1;

FIG. 5 is a fragmentary schematic sectional view, generally similar to FIGS. 1 and 2, illustrating the manner in which a dispensed product moves into the product retrieval location in the vending machine of FIG. 1;

FIG. 6 is a fragmentary schematic sectional view, generally similar to FIGS. 2 and 5, illustrating the manner in which downward movement of a product is stopped by engagement with a surface at the product retrieval location in the vending machine of FIG. 1;

FIG. 7 is a fragmentary schematic sectional view, generally similar to FIGS. 5 and 6, illustrating the manner in which the surface engaged by a product is moved to effect a change in the orientation of the product at the product retrieval location in the vending machine of FIG. 1;

FIG. 8 is a fragmentary schematic sectional view, generally similar to FIGS. 5-7, illustrating the manner in which a dispensed product is supported at the product retrieval location; and

FIG. 9 is a fragmentary schematic section view, generally similar to FIG. 2, of a second embodiment of the vending machine.

### DESCRIPTION OF SPECIFIC EMBODIMENTS OF THE INVENTION GENERAL DESCRIPTION

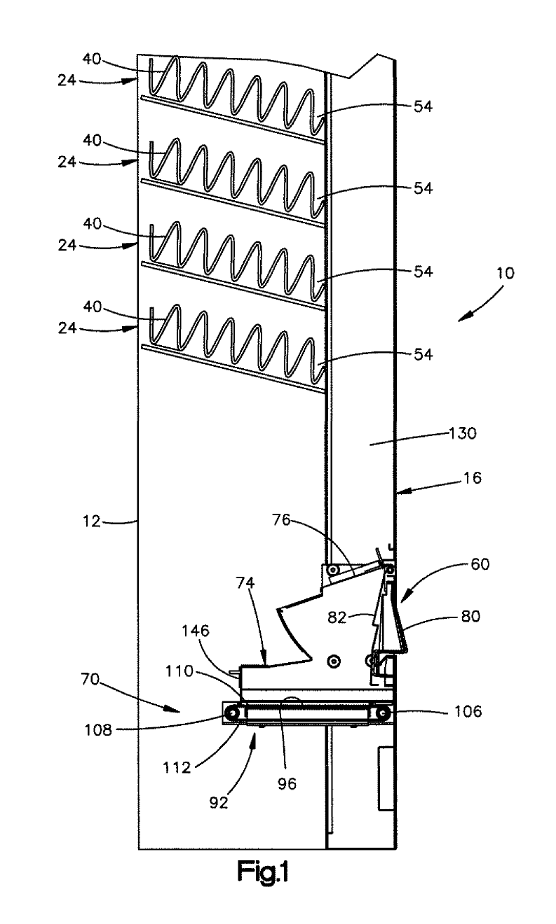

A vending machine 10 (FIG. 1) is constructed and operated in accordance with the present invention. The vending machine 10 includes a rectangular housing 12 having a main door 16. The main door 16 has a transparent window or panel (not shown). If desired, an opaque panel may be used in the main door 16 instead of a window. The door 16 is pivotally mounted on hinges (not shown) connected to side walls of the housing 12 in a known manner.

Disposed within the housing 12 are a plurality of product dispensing devices 24. In FIG. 1, the product dispensing devices 24 are all shown as being empty, that is, before the product dispensing devices are stocked with products to be dispensed. It should be understood that the product dispensing devices 24 may have any desired construction and be used to dispense any desired product.

Each of the product dispensing devices 24 includes a conveyor assembly 40 having a known construction. Each of the conveyor assemblies 40 includes a pair of helical conveyor elements which engage products to be dispensed. The helical conveyor elements are rotatable about parallel longitudinal central axes relative to a tray on which products are disposed. The helical conveyor elements may be referred to as “spirals”. If desired, the conveyor assembly 40 may include only a single helical conveyor element. It should be understood that the conveyor elements 40 may have a different construction.

When a product is to be dispensed from a product dispensing location 54 and a next succeeding product is to be advanced from a storage location to the product dispensing location, one pair of helical conveyor elements are rotated in opposite directions about their longitudinal central axes. Rotation of the one pair of conveyor elements is effective to move the product at the dispensing location 54 off of the tray so that the product drops downward between the trays and the window in the door 16. The dispensed product moves downward from the product dispensing location 54 to a product retrieval location 60.

A different type of dispensing device 24 may be utilized if desired. For example, indexing or pusher elements may be connected with a continuous belt or chain conveyor and utilized to push products. Alternatively, a circular disc may be intermittently rotated to move products. As another alternative, gravity feed conveyors may be utilized.

The selected product moves downward, as viewed in FIG. 1, from a product dispensing location 54 to the product retrieval location 60 under the influence of gravity. It should be understood that a selected product may reach the product retrieval location 60 in ways other than falling. For example, the product could be scooped up or gripped and set on a surface at the product retrieval location. If desired, various elevators or x/y delivery systems may be used.

The vending machine 10 has a construction which is generally similar to the construction of a vending machine disclosed in U.S. Patent Publication No. 2010/0094457 published Apr. 15, 2010 and entitled Method and Apparatus for Use in a Vending Machine. The disclosure in the aforementioned United States Patent Application Publication No. 2010/0094457 is hereby incorporated herein in its entirety by this reference thereto.

### Product Retrieval Apparatus

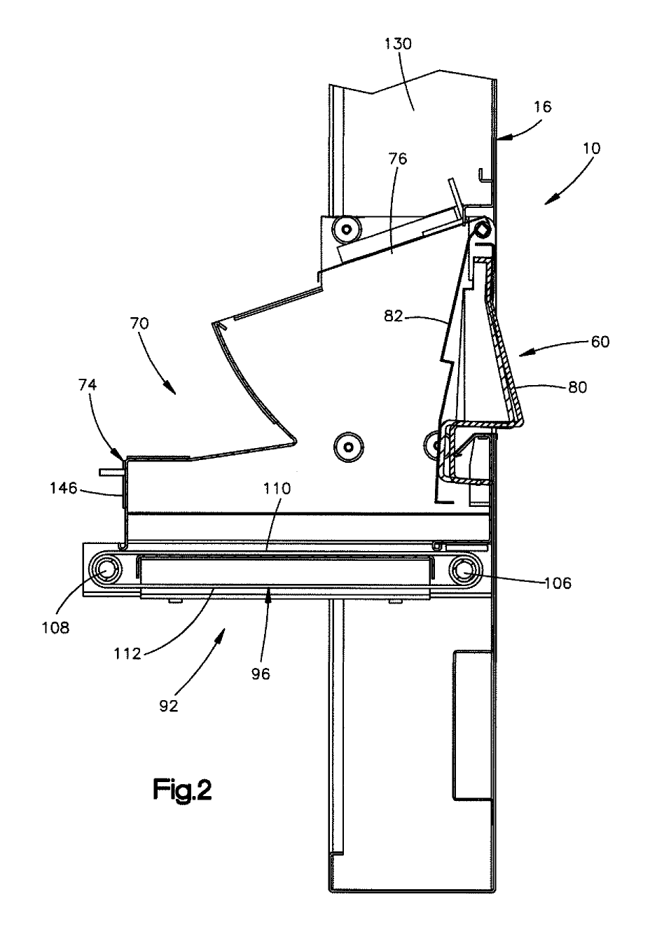

A product retrieval apparatus 70, constructed and operated in accordance with the present invention, is mounted on the main door 16 (FIGS. 2, 3 and 4). The product retrieval apparatus 70 includes a bucket or housing 74 which is fixedly connected to the main door 16. When the main door 16 is moved from the closed position of FIG. 1 to an open position, the product retrieval apparatus 70 moves with the door.

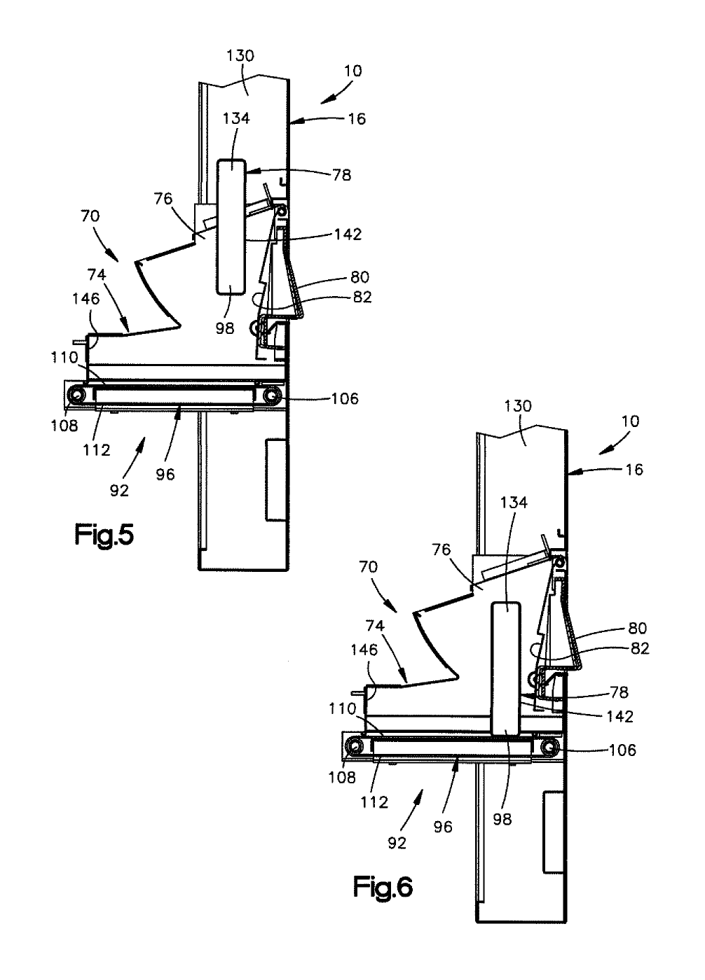

The bucket or housing 74 has an upwardly facing entrance opening 76 (FIG. 2) through which a selected product 78 (FIG. 5) enters the product retrieval apparatus 70. The selected product 78 enters the product retrieval apparatus 70 in an upright orientation. When the selected product enters the product retrieval apparatus 70, a longitudinal central axis of the selected product 78 is generally vertical. Therefore, the selected product 78 has a maximum vertical extent when the selected product enters the product retrieval apparatus 70. Of course, the selected product 78 may have a different orientation when it enters the product retrieval apparatus 70.

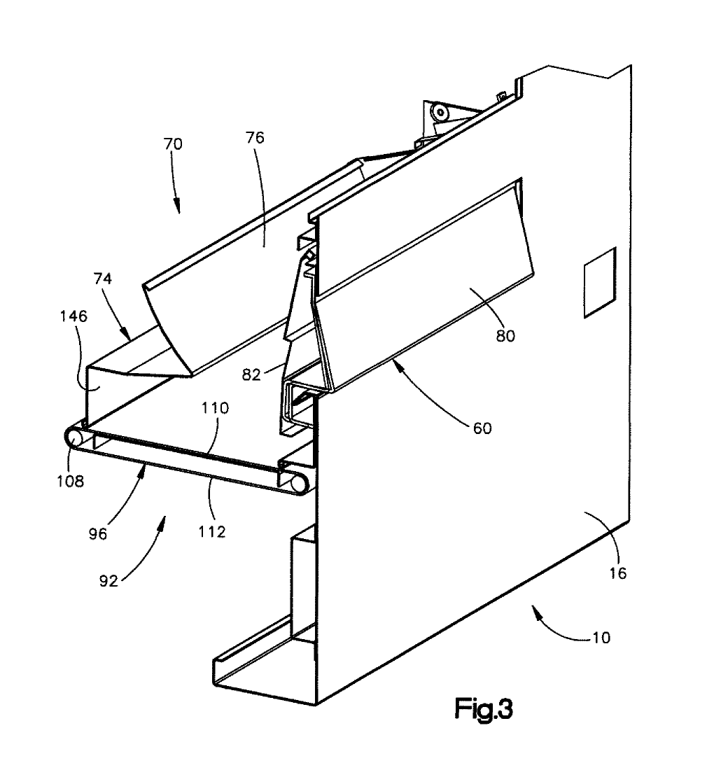

In addition, the product retrieval apparatus 70 includes a delivery door 80 (FIGS. 2 and 3) and a supply or anti-pilferage door 82. The delivery door 80 and the supply or anti-pilferage door 82 are both pivotally mounted on the main door 16 of the vending machine 10. The delivery door 80 is manually pivoted in a clockwise direction, as viewed in FIGS. 2 and 3, by a customer seeking access to a selected product in the product retrieval apparatus 70.

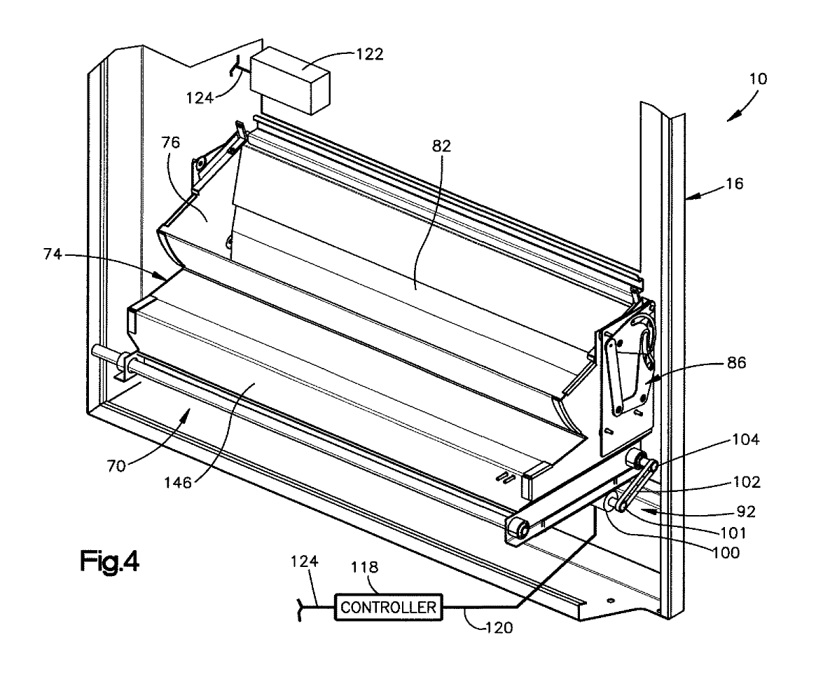

A linkage assembly 86 (FIG. 4) is mounted on the housing 74 and is connected with the delivery door 80 (FIG. 2) and the supply or anti-pilferage door 82. When the delivery door 80 is manually pivoted in a clockwise direction (as viewed in FIG. 2), the supply or anti-pilferage door 82 is also pivoted in a clockwise direction. The linkage assembly 86 (FIG. 4) has a known construction and causes the supply or anti-pilferage door 82 to swing from its closed position ahead of the delivery door 80. This blocks access to the entrance opening 76 and products stored above the entrance opening, as the delivery door 80 is opened.

The linkage assembly 86 (FIG. 4) has a known construction which is generally similar to the construction of a linkage assembly disclosed in U.S. Pat. No. 4,094,440. However, it is contemplated that the linkage assembly 86 may have a different construction if desired. For example, the linkage assembly 86 may be constructed in a manner similar to that disclosed in U.S. Pat. Nos. 3,174,646; 4,296,872 and/or 5,909,823. The linkage assembly 86 is constructed so that when the delivery door 80 is moved toward its open position, the supply or anti-pilferage door 82 blocks access to the entrance opening 76 before the delivery door 80 reaches its open position.

### Drive Assembly

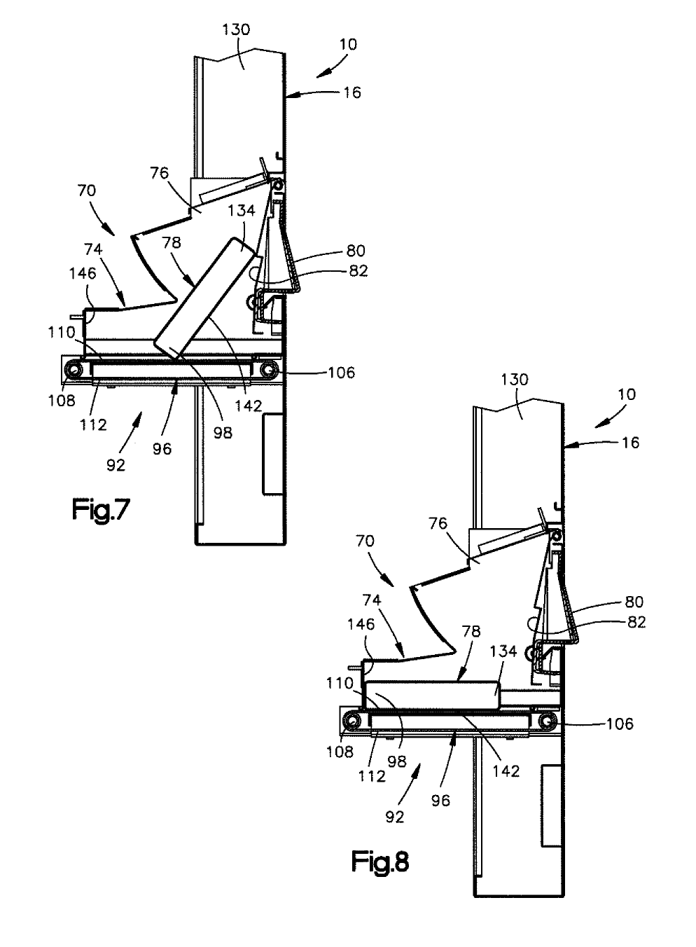

The product retrieval apparatus 70 includes a drive assembly 92 which is operable to apply a force to a selected product 78 to move the selected product from the initial orientation illustrated in FIG. 6 through the orientation illustrated in FIG. 7 to the retrieval orientation illustrated in FIG. 8. Although it is contemplated that the drive assembly 92 may have any one of many different constructions, the illustrated drive assembly 92 includes a movable surface which engages a lower end portion 98 of a selected product 78 in the manner illustrated schematically in FIGS. 6 and 7.

In the specific drive assembly illustrated in FIGS. 2, and 5-8, the movable surface is disposed on a belt 96. However, the movable surface may be disposed on a member other than the belt 96. For example, the movable surface may be disposed on a plate or other piece of material.

Force applied to the lower end portion 98 of the selected product 78 by the belt 96 causes the selected product to rotate through approximately 90 degrees from the orientation illustrated in FIG. 6 through the orientation illustrated in FIG. 7 to the orientation illustrated in FIG. 8. However, the selected product 78 may be rotated through an angle which is either larger or smaller than 90°. For example, the selected product 78 may be rotated through 60°. As another example, the selected product 78 may be rotated through 120°.

The illustrated drive assembly 92 (FIG. 4) includes an electric motor 100. When the electric motor 100 is energized, a pulley 101 drives a belt 102 to rotate a pulley 104. The pulley 104 is connected with a roller 106 (FIG. 2) around which the belt 96 extends. The belt 96 also extends around an idler pulley 108 to maintain tension in upper and lower runs 110 and 112 of the belt 96. Although only one belt 96 is used in the embodiment illustrated in FIGS. 1-3, two or more belts may be utilized if desired.

The roller 106 may be disposed at a lower level than the roller 108. This would promote movement of the selected product 78 toward the delivery and anti-pilferage doors 80 and 82. Alternatively, the roller 108 may be disposed at a lower level than the roller 106. This would promote movement of the selected product 78 away from the doors 80 and 82.

Operation of the motor 100 results in the drive roller 106 being rotated in a counterclockwise direction (as viewed in FIG. 2). The upper run 110 of the belt 96 moves away from the delivery door 80. Of course, the lower run 112 of the continuous belt 96 moves toward the delivery door 80 as the upper run 110 of the belt is moves away from the delivery door. The belt 96 extends across the product retrieval location 60 so that a portion of the belt is disposed directly below each of the product delivery locations 54. The flat horizontal upper run 110 (FIG. 2) of the belt 96 spans the entire lower side of the housing 74.

Regardless of which product dispensing device 24 (FIG. 1) is used to dispense a selected product 78, the selected product will move downward along the channel 130 and through the entrance opening 76 (FIG. 5). After at least a portion of a selected product 78 from any one of the product dispensing locations 54 moves through the entrance opening 76, the lower end portion 98 of the selected product engages the upper run 110 of the belt 96 (FIG. 6). If the belt 96 is replaced with a movable panel, the panel would span the entire lower side of the housing 74 and be movable by a suitable motor. This motor may be a solenoid.

A controller 118 (FIG. 4) is connected with the motor 100 by a lead 120 and is effective to energize the motor in response to detection of a selected product by a detector 122. The detector 122 is connected with the controller 118 by a lead 124. The detector 122 is an imaging device which is activated to obtain an image of the product while it is dropping and/or while it is at the retrieval location 60.

The detector 122 has the same construction as the imaging device disclosed in the aforementioned U.S. Patent Publication No. 2010/0094457. The detector 122 obtains an image of a product 78 while it is dropping and/or while it is at the retrieval location. However, it is contemplated that the imaging device may have the same construction and be utilized in the same manner as the imaging device disclosed in U.S. Patent Publication No. 2010/0237091 to obtain an image of a selected product after it has been dispensed. The disclosure in the aforementioned U.S. Patent Publication No. 2010/0237091 is hereby incorporated herein in its entirety by this reference thereto.

Although the detector 122 is an imaging device, it is contemplated that a different type of detector may be utilized to detect the presence of a selected product at the product retrieval location 60. For example, product detectors similar to those disclosed in U.S. Pat. Nos. 7,191,034; 7,286,901 and/or 7,343,220 may be utilized. Of course, any known type of detector may be utilized if desired.

It is contemplated that the detector 122 may be eliminated and the motor 100 operated to drive the belt 96 whenever a product is to be dispensed. If this is done, the motor 100 would be maintained in an energized condition driving the belt for a predetermined period of time after the product has been dispensed. This period of time would be sufficient to enable the product to fall from an upper most product dispensing device 24 onto the belt 96 and to move through a distance sufficient to change the orientation of the selected product relative to the product retrieval location 60.

The belt 96 extends across the product retrieval location 60 so that a portion of the belt is disposed directly below each of the product delivery locations 54. The upper run 110 (FIG. 2) of the belt 96 spans the entire lower side of the housing 74. Regardless of which product dispensing device 24 (FIG. 1) is used to dispense a selected product 78, the selected product will move downward along the channel 130 and through the entrance opening 76 (FIG. 5). After at least a portion of a selected product 78, from any one of the product dispensing locations 54, moves through the entrance opening 76, the lower end portion 98 of the selected product engages the flat horizontal upper run 110 of the belt 96 (FIG. 6).

The belt 96 illustrated in FIGS. 1-3 and 5-8 is a single continuous web which extends across the bottom of the housing 74. However, the belt 96 could be formed by a plurality of separate sections which extend around the rollers 106 and 108. For example, the belt 96 could be formed by a series of continuous bands which are disposed in a side-by-side relationship and extend around the rollers 106 and 108. As was previously mentioned, the movable surface may be formed by an apparatus other than a motor driven belt.

### Operation

When one of the product dispensing devices 24 (FIG. 1) is operated to dispense a selected product 78 at a product dispensing location 54 in response to a selection made by a customer, the selected product (FIG. 5) moves into a vertical channel or passage 130 (FIGS. 1, 2 and 5) formed in the door 16. The selected product 78 moves downward in the channel or passage 130 toward the product retrieval location 60 under the influence of gravity. The detector 122 detects the selected product 78 as it moves toward and as it moves through the entrance opening 78. As the selected product 78 moves downward, it moves into the bucket or housing 74 with the lower end portion 98 leading. At this time, the selected product 78 is in an upright orientation with a central axis of the selected product extending generally parallel to a vertical central axis of the channel 130.

The selected product continues to move downward until the lower or leading end portion 98 of the selected product 78 engages the upper run 110 of the belt 96, in the manner illustrated schematically in FIG. 6. The detector 122 effects energization of the motor 100 in response to detection of the selected product 78. The motor 100 may be energized, by the detector 122, shortly before the lower end portion 98 of the selected product 78 engages the upper run 110 of the belt 96. Alternatively, the motor 100 may be energized shortly after the lower end portion 98 of the selected product 78 engages the upper run 110 of the belt 96.

The upper run 110 of the belt 96 applies force against the lower end portion 98 of the selected product 78 to rotate the selected product about its lower end portion, in the manner illustrated schematically in FIG. 7. Thus, as the lower end portion 98 of the selected product 78 is moved toward the left (as viewed in FIG. 7) by the belt 96. At this occurs, the belt 96 moves the lower end portion 98 of the selected product away from the doors 80 and 82. The selected product 78 rotates in a clockwise direction (as viewed in FIG. 7) about the location where the selected product 78 engages the upper run 110 of the belt 96. As this occurs, an upper or trailing end portion 134 of the selected product 78 moves downwardly along the supply or anti-pilferage door 82 toward the belt 96.

Movement of the upper run 110 of the belt 96 toward the left (as viewed in FIG. 7) continues until a longitudinally extending side portion 142 (FIG. 7) of the selected product 78 is disposed in engagement with the upper run 110 of the belt 96 in the manner illustrated schematically in FIG. 8. At this time, the upper end portion 134 of the selected product 78 will be disposed adjacent to the supply or anti-pilferage door 82 and delivery door 80 while the lower end portion 98 of the selected product 78 is adjacent to an end or stop wall 146 of the bucket or housing 74. The motor 100 is then deenergized by the controller 118 (FIG. 4) and movement of the belt is stopped.

Once the selected product 78 has been moved to the horizontal orientation illustrated in FIG. 8, the customer manually applies force against the delivery door 80. This force causes the linkage assembly 86 to pivot the supply or anti-pilferage door 82 upward, that is, in a clockwise direction as viewed in FIG. 8, to block access to the entrance opening 76 and products disposed above the product retrieval location in the product dispensing devices 24 (FIG. 1). After the supply or anti-pilferage door 82 has blocked access to the entrance opening 76, the delivery door 80 moves to an open condition providing access to the stationary selected product 78 disposed on the belt 96 (FIG. 8) at the product retrieval location 60.

After the customer has manually retrieved the selected product 78, the delivery door 80 is released. The delivery door 80 then swings back to the closed position illustrated in FIG. 8. As this occurs, the linkage assembly 86 causes the supply or anti-pilferage door 82 to move toward the closed position shown in FIG. 8.

It is contemplated that devices other than the belt 96 may be used to apply force to the lower end portion 98 of a selected product 78 at the product retrieval location 60. For example, a reciprocating drive member could be moved into engagement with the selected product and moved leftward (as viewed in FIG. 6) to apply force against the selected product. This drive member may be mounted adjacent to the doors 80 and 82 and be extended toward the left (as viewed in FIG. 6) to apply a pushing force against the selected product 78. Alternatively, the drive member may be mounted adjacent to a portion of the housing 74 spaced from the doors and be retracted toward the left (as viewed in FIG. 6) to apply a pulling force against the selected product 78. The drive member may apply force against any portion of the selected product 78 disposed between opposite ends of the selected product.

### Alternative Embodiment

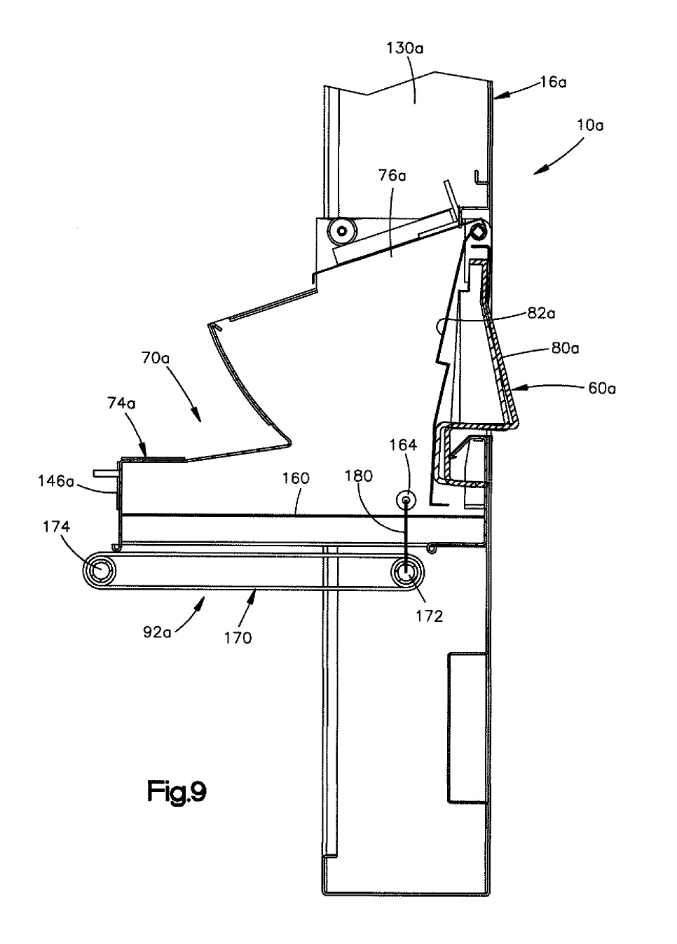

In the embodiment of the invention illustrated in FIGS. 1-8, the movable surface formed by the belt 96 is used to apply force to the lower end portion 98 of the selected product to change the orientation of the selected product from the generally upright orientation illustrated schematically in FIGS. 5 and 6 to the horizontal orientation illustrated in FIG. 8. In the embodiment of the invention illustrated in FIG. 9, a sweeper member applies force to the lower end portion of the selected product to change the orientation of the selected product. Since the embodiment of invention illustrated in FIG. 9 is generally similar to the embodiment of the invention illustrated in FIGS. 1-8, similar numerals will be utilized to identify similar components the suffix letter “a” being added to the numerals of FIG. 9 to avoid confusion.

A vending machine 10a has a main door 16a which is connected to a housing, corresponding to the housing 12 of the vending machine of FIG. 1. Suitable product dispensing devices, corresponding to the product dispensing devices 24 of FIG. 1, are disposed in the housing of the vending machine 10a. The product dispensing devices have product dispensing locations corresponding to the product dispensing locations 54 of the FIG. 1.

Selected products are dispensed from the product dispensing devices into a channel 130a (FIG. 9) formed in the main door 16a. The selected products move downward through an entrance opening 76a to a product retrieval apparatus 70a disposed at a product retrieval location 60a in the vending machine 10a. The selected products move through the opening 76a with the selected products in the same orientation as the selected product 78 of FIG. 5.

The product retrieval apparatus 70a includes a housing 74a having a bottom wall 160 (FIG. 9). The flat horizontal bottom wall 160 spans the entire bottom of the housing 74a. A portion of the bottom wall 160 is disposed directly below each of the product dispensing locations in the vending machine 10a. The bottom wall 160 is engaged by a lower end portion of a selected product as the selected product moves downward along the channel 130a and through the entrance opening 76a into the housing 74a. The lower end portion of the selected product engages the stationary bottom wall 160 and stops downward movement of the selected product. At this time, the selected product is in an upright orientation, corresponding to the orientation of the selected product 78 in FIG. 6. However, rather than engaging a belt, the lower end portion, designated 98 in FIG. 6, of the selected product engages the flat stationary bottom wall 160 (FIG. 9) of the housing 74a. The selected product may be dispensed from any one of product dispensing devices in the vending machine 10a.

In accordance with one of the features of the embodiment of the invention illustrated in FIG. 9, a drive assembly 92a is operated to move a sweeper member 164 across the entire bottom wall 160 of the housing 74a. Thus, the drive assembly 92a is operable to move the sweeper member 164 leftward (as viewed in FIG. 9) from an initial position adjacent to the delivery door 80a and supply or anti-pilferage door 82a to an end of stroke position adjacent to an end wall 146a of the housing 74a. The sweeper member extends between opposite edge portions of the bottom wall 160.

As the sweeper member 164 is moved leftward (as viewed in FIG. 9) through its operating stroke by the drive assembly 92a, the sweeper member moves into engagement with an upwardly extending side portion of the selected product 78a. Thus, the sweeper member 164 moves into engagement with a side portion corresponding to the side portion 142 of the selected product 78 in FIG. 7. Continued operation of the drive assembly 92a causes the sweeper member 164 to move across the entire upper surface of the bottom wall 160.

Force applied against the side portion of the upright selected product by the sweeper member 164 causes the selected product to rotate about its lower end portion, corresponding to the lower end portion 98 of the selected product 78 in FIG. 7. As this occurs, the lower end portion of the selected product slides along the bottom wall 160 toward the end wall 146a. This results in the selected product rotating in a clockwise direction (as viewed in FIG. 9) in much the same manner as previously explained for the selected product 78 in conjunction with FIGS. 7 and 8.

In the illustrated embodiment of the invention, the sweeper member 164 is a rigid cylindrical rod. However, the sweeper member 164 may have a flexible construction. The sweeper member 164 may be formed by a wire or string.

The drive assembly 92a includes an endless drive belt 170 which extends around a drive pulley and an idler pulley 174. The drive pulley 172 is driven by a reversible electric motor, corresponding to the motor 100 of FIG. 4, which is connected with a controller corresponding to the controller 118 of FIG. 4. The sweeper member 164 is connected with the belt 170 by a pair of support arms 180. Although only one support arm 180 is illustrated schematically in FIG. 9, it should be understood that support arms are provided at opposite ends of the sweeper member 164. The support arms 180 are fixedly connected to the belt 170 so that when the drive pulley 172 is operated, the sweeper member is moved leftward (as viewed in FIG. 9) across the bottom wall 160 of the housing 74a under the influence of force transmitted from the belt 170 to the sweeper member through the support arms 180.

After the delivery door 80a and the supply or anti-pilferage door 82a have been moved to their open positions, the selected product is removed from the housing 74a by a customer. Once the customer has manually removed the selected product from the housing 74a, the delivery door 80a and supply or anti-pilferage door 82a move back to their closed positions illustrated in FIG. 9. Once this has occurred, the direction of operation of the drive motor and rotation of the drive pulley 172 are reversed and the sweeper member 164 is moved from the left (as viewed in FIG. 9) end portion of the bottom wall 160, that is, from a location adjacent to the end wall 146a, back to the initial position illustrated in FIG. 9 adjacent to the doors 80a and 82a.

Rather than using a sweeper member 164 to apply force to a lower end portion of a selected product, a plurality of air jets may be utilized to apply force against the lower end portion of the selected product. If this is done, the air jets may be arranged so as to form a curtain of air which extends across the bottom wall 160 of the housing 74a. Alternatively, detectors may be provided to detect which nozzles, of a liner array of nozzles, are to direct one or more streams of air toward the lower end portion of the selected product.

### CONCLUSION

In view of the foregoing description, it is apparent that the present invention provides new and improved method and apparatus for use in a vending machine 10 having a plurality of product dispensing devices 24 and a product retrieval location 60 where a customer has access to a selected product 78. The selected product 78 is moved from one of the product dispensing devices 24 to the product retrieval location 60. The selected product 78 moves to the product retrieval location in a first orientation (FIG. 5). The orientation of the selected product 78 is changed from the first orientation to a second orientation (FIG. 8) while the selected product is at the product retrieval location 60.

The vertical extent of the selected product 78 may be greater when it is in the first orientation (FIG. 5) than it is when it is in the second orientation (FIG. 8). By having the vertical extent of the product 78 minimized when the product is in the second orientation (FIG. 8), the vertical extent of the product retrieval location 60 may be minimized.

To change the orientation of the selected product 78 from the first orientation (FIG. 5) to the second orientation, (FIG. 8) a force may be applied to a lower end portion 98 of the selected product. This may be accomplished by moving a surface while an end portion 98 of the selected product is in engagement with the surface. Alternatively, the orientation of the selected product 78 may be changed from the first orientation (FIG. 5) to the second orientation by moving a sweeper member 164 across a surface 160 which is engaged by the selected product.

The present invention has a number of different features. These features may be utilized together as disclosed herein. These features may be utilized separately and/or in various combinations with each other or the prior art.

Having described the invention, the following is claimed:

1. A method comprising the steps of providing a vending machine having a plurality of product dispensing devices and a product retrieval location where a customer has access to a selected product, moving a selected product from one of the product dispensing devices to the product retrieval location with the selected product in a first orientation, and changing the orientation of the selected product from the first orientation to a second orientation while the selected product is at the product retrieval location.

2. A method as set forth in claim 1 wherein said step of changing the orientation of the selected product from the first orientation to the second orientation includes moving a lower end portion of the selected product away from a door through which the customer has access to the product retrieval location.

3. A method as set forth in claim 2 wherein said step of moving a lower end portion of the selected product away from a door includes moving a portion of a belt which is engaged by the lower end portion of the product away from the door.

4. A method as set forth in claim 2 wherein said step of moving a lower end portion of the selected product away from a door includes moving a sweeper member across a surface engaged by the lower end portion of the product and in a direction away from the door.

5. A method as set forth in claim 1 wherein said step of moving a selected product from one of the product dispensing devices to the product retrieval location includes moving the selected product downward with a first end portion of the selected product leading and a second end portion of the selected product trailing, said step of changing the orientation of the selected product includes moving the first end portion of the selected product away from a door through which the customer has access to the product retrieval location and moving the second end portion of the selected product toward the door through which the customer has access to the product retrieval location.

6. A method as set forth in claim 5 wherein said step of moving the second end portion of the selected product toward the door includes rotating the selected product to move the second end portion of the selected product toward the door along an arcuate path.

7. A method as set forth in claim 5 wherein said step of moving the first end portion of the selected product away from the door includes moving a surface area engaged by the first end portion of the selected product away from the door.

8. A method as set forth in claim 5 wherein said step of moving the first end portion of the selected product away from the door includes moving a sweeper member across a surface engaged by the first end portion of the selected product and in a direction away from the door.

9. A method as set forth in claim 5 wherein said step of moving the first end portion of the selected product away from the door includes moving a portion of a belt which is engaged by the first end portion of the selected product away from the door.

10. A method as set forth in claim 1 further including the step of stopping movement of the selected product at the product retrieval location by engaging a surface with an end portion of the selected product, said step of changing the orientation of the selected product from the first orientation to the second orientation includes moving the surface while the end portion of the selected product is in engagement with the surface.

11. A method as set forth in claim 10 wherein said step of engaging a surface with an end portion of the product includes engaging a belt with the end portion of the selected product, said step of moving the surface while the end portion of the selected product is in engagement with the surface includes moving the belt along an endless path.

12. A method as set forth in claim 10 wherein said step of moving the surface while the end portion of the selected product is in engagement with the surface includes moving the surface away from a door through which the customer has access to the product retrieval location.

13. A method as set forth in claim 1 further including the step of stopping moving of the selected product at the product retrieval location by engaging a surface with an end portion of the selected product, said step of changing the orientation of the selected product from the first orientation to the second orientation includes moving a side portion which extends between opposite end portions of the selected product into engagement with the surface.

14. A method as set forth in claim 13 wherein said step of moving the side portion of the selected product into engagement with the surface includes rotating the selected product about a location where the end portion of the selected product engages the surface.

15. A method as set forth in claim 13 wherein said step of engaging a surface with an end portion of the selected product includes engaging a belt with the end portion of the selected product, said step of moving a side portion of selected product into engagement with the surface includes moving the belt relative to the product dispensing devices.

16. A method as set forth in claim 13 wherein said step of changing the orientation of the selected product from the first orientation to the second orientation includes moving a sweeper member across the surface engaged by the selected product.

17. A method as set forth in claim 13 wherein said step of changing the orientation of the selected product from the first orientation to the second orientation includes moving an end portion of the selected product away from a door through which the customer has access to the product retrieval location.
